(19) United States
(12) Patent Application Publication
(10) Pub. No.: US 2013/0271759 A1
(43) Pub. Date: Oct. 17, 2013

(54) APPARATUS AND METHOD FOR PERFORMING SPECTROSCOPY

(71) Applicants: David A. Fattal, Mountain View, CA (US); Raymond G. Beausoleil, Redmond, WA (US); Kai-Mei Camilla Fu, Palo Alto, CA (US)

(72) Inventors: David A. Fattal, Mountain View, CA (US); Raymond G. Beausoleil, Redmond, WA (US); Kai-Mei Camilla Fu, Palo Alto, CA (US)

(21) Appl. No.: 13/976,346

(22) PCT Filed: Jan. 31, 2011
(86) PCT No.: PCT/US11/23219

§ 371 Date: Jun. 26, 2013

(51) Int. Cl. G01N 21/65

(52) U.S. Cl. CPC G01N 21/65
USPC 356/301

(57) ABSTRACT

An apparatus for performing spectroscopy includes a substrate, a photodetector positioned at a distance with respect to the substrate, and a plurality of sub-wavelength grating (SWG) filters positioned between the substrate and the photodetector, in which the SWG filters are to filter different ranges of predetermined wavelengths of light emitted from an excitation location prior to being emitted onto the photodetector.

### CROSS-REFERENCE TO RELATED APPLICATIONS

The present application has the same Assignee and shares some common subject matter with PCT Application No. PCT/US2009/051026, entitled “NON-PERIODIC GRATING REFLECTORS WITH FOCUSING POWER AND METHODS FOR FABRICATING THE SAME”, filed on Jul. 17, 2009, PCT Application Serial No. PCT/US2009/058006, entitled “OPTICAL DEVICES BASED ON DIFFRACTION GRATINGS”, filed on Sep. 23, 2009, U.S. Patent Application Serial No. 12/696,682, entitled “DYNAMICALLY VARYING AN OPTICAL CHARACTERISTIC OF A LIGHT BEAM”, filed on Jan. 29, 2010, the disclosures of which are hereby incorporated by reference in their entireties.

### BACKGROUND

Detection and identification or at least classification of unknown substances has long been of great interest and has taken on even greater significance in recent years. Among advanced methodologies that hold a promise for precision detection and identification are various forms of spectroscopy, especially those that employ Raman scattering. Spectroscopy may be used to analyze, characterize and even identify a substance or material using one or both of an absorption spectrum and an emission spectrum that results when the material is illuminated by a form of electromagnetic radiation (for instance, visible light). The absorption and emission spectra produced by illuminating the material determine a spectral ‘fingerprint’ of the material. In general, the spectral fingerprint is characteristic of the particular material or its constituent elements facilitating identification of the material. Among the most powerful of optical emission spectroscopy techniques are those based on Raman-scattering.

Raman-scattering optical spectroscopy employs an emission spectrum or spectral components thereof produced by inelastic scattering of photons by an internal structure of the material being illuminated. These spectral components contained in a response signal (for instance, a Raman signal) may facilitate determination of the material characteristics of an analyte species including identification of the analyte.

Unfortunately, the Raman signal produced by Raman-scattering is extremely weak in many instances compared to elastic or Rayleigh scattering from an analyte species. The Raman signal level or strength may be significantly enhanced by using a Raman-active material (for instance, Raman-active surface), however. For instance, the Raman scattered light generated by a compound (or ion) adsorbed on or within a few nanometers of a structured metal surface can be 10³-10¹² times greater than the Raman scattered light generated by the same compound in solution or in the gas phase. This process of analyzing a compound is called surface-enhanced Raman spectroscopy (“SERS”). In recent years, SERS has emerged as a routine and powerful tool for investigating molecular structures and characterizing interfacial and thin-film systems, and even enables single-molecule detection. Current SERS spectroscopy apparatuses are typically constructed with diffraction or interference filters, which are known to be relatively large and expensive to manufacture.

### BRIEF DESCRIPTION OF THE DRAWINGS

Features of the present disclosure are illustrated by way of example and not limited in the following figure(s), in which like numerals indicate like elements, in which:

FIG. 1 shows a cross-sectional side view of an apparatus for performing spectroscopy, according to an example of the present disclosure;

FIG. 2A shows a perspective view of the apparatus depicted in FIG. 1, according to another example of the present disclosure;

FIG. 2B shows a cross-sectional side view of the apparatus depicted in FIG. 1, according to another example of the present disclosure;

FIGS. 2C-2D show cross-sectional side views of the apparatus depicted in FIG. 2A at different times during a spectroscopy operation on an excited molecule, according to an example of the present disclosure;

FIGS. 3A-3C illustrate respective bottom plan views of a sub-wavelength dielectric grating, according to examples of the present disclosure;

FIG. 4 shows a flow diagram of a method for performing spectroscopy, according to an example of the present disclosure;

FIG. 5 shows a flow diagram of a method for fabricating a spectroscopy apparatus, according to an example of the present disclosure; and

FIG. 6 shows a schematic representation of a computing device that may be implemented to perform various functions with respect to the apparatus depicted in FIGS. 1-2D, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures are not described in detail so as not to unnecessarily obscure the description of the present disclosure.

Disclosed herein are an apparatus and method for performing spectroscopy, such as, surface enhanced Raman spectroscopy (SERS), reflection absorption infrared spectroscopy (RAIRS), etc. The apparatus includes a substrate, which may include SERS-active nano-particles, a photodetector, and a plurality of sub-wavelength grating (SWG) filters positioned to filter light emitted onto the photodetector. Also disclosed herein is a method for fabricating the apparatus for performing spectroscopy, which includes fabrication of the SWG filters. According to an example, the SWG filters are each fabricated on a common block of material and are fabricated to filter out different wavelength bands of light. More particularly, for instance, the wavelength bands that the SWG filters are to filter out correspond to the wavelengths of light in a spectrum of Raman scattered light known to be emitted by a particular type of molecule. In this regard, the apparatus disclosed herein may be designed to detect a particular type of molecule. Alternatively, however, a relatively large number of diverse SWG filters may be employed to detect the spectrum of Raman scattered light emitted by an excited molecule.

According to another example, a grating lens is positioned between the SWG filters and the substrate. The grating lens is designed to focus the Raman scattered light emitted from an excited molecule onto the SWG filter(s). The grating lens and/or the SWG filters may be fabricated on a transparent block to substantially maintain a fixed distance between the grating lens and the SWG filters. In addition, the grating lens, which may also comprise an SWG layer, and the SWG filters may be fabricated directly on the transparent block to thereby ease fabrication of the grating lens and the SWG filters. The other components of the apparatus may also be formed or attached to the transparent block to form a substantially monolithic structure.

Through implementation of the apparatuses and methods disclosed herein, particular types of molecules may be detected in a relatively inexpensive and efficient manner. In addition, the apparatus may be fabricated to have a relatively small form factor, thereby making the apparatus suitable for hand-held use. Moreover, because the SWG filters and SWG grating lens implemented in the apparatus disclosed herein are generally less expensive and are smaller than the diffraction or interference filters employed in conventional SERS spectroscopy apparatuses, the spectroscopy apparatus disclosed herein may be relatively smaller and less expensive to manufacture as compared with conventional SERS spectroscopy apparatuses.

Throughout the present disclosure, the terms “a” and “an” are intended to denote at least one of a particular element. As used herein, the term “includes” means includes but not limited to, the term “including” means including but not limited to. The term “based on” means based at least in part on. In addition, the term “light” refers to electromagnetic radiation with wavelengths in the visible and non-visible portions of the electromagnetic spectrum, including infrared and ultra-violet portions of the electromagnetic spectrum.

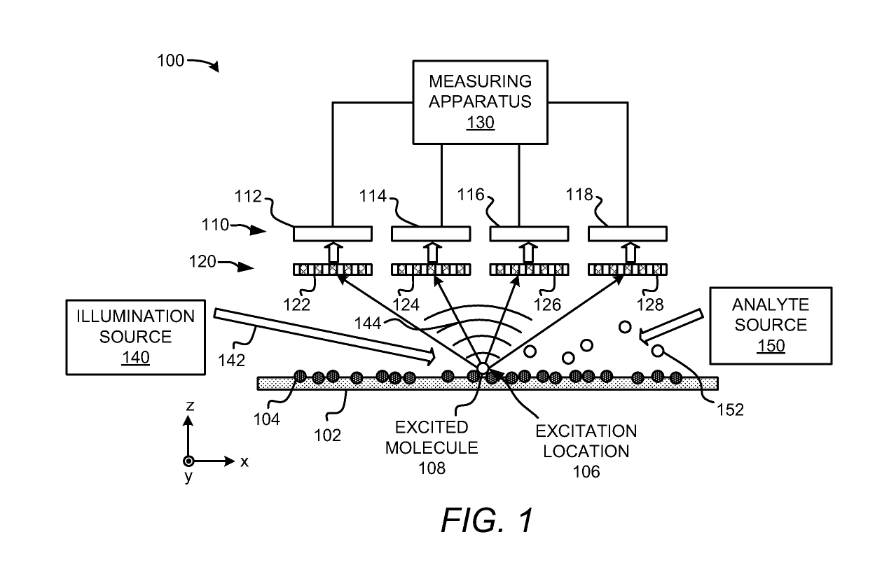

With reference first to FIG. 1, there is shown a cross-sectional side view of an apparatus 100 for performing spectroscopy, according to an example. It should be understood that the apparatus 100 depicted in FIG. 1 may include additional components and that some of the components described herein may be removed and/or modified without departing from a scope of the apparatus 100. In addition, it should be understood that the apparatus 100 has not been drawn to scale, but instead, has been drawn to clearly show the relationships between the components of the apparatus 100.

As depicted in FIG. 1, the apparatus 100 includes a substrate 102, an array of photodetectors 110, and an array of filters 120. The array of photodetectors 110 and/or the array of filters 120 may comprise a one-dimensional or a two-dimensional array of photodetectors 110 and/or filters 120. Also shown in FIG. 1 are a measuring apparatus 130, an illumination source 140, and an analyte source 150. According to an example, the apparatus 100 is fabricated as a single, hand-held device, for instance, on a single chip.

By way of example in which the apparatus 100 is to perform surface enhanced Raman spectroscopy (SERS) to detect whether an analyte introduced onto the substrate 102 contains a particular type of molecule based upon, for instance, the spectrum of wavelengths of light 144, such as Raman scattered light, emitted by an excited molecule 108 of the analyte in response to receipt and absorption of an excitation light 142 from the illumination source 140 at an excitation location 106 of the substrate 102. More particularly, when the excitation light 142 is directed onto a molecule 108 at an optical frequency, the module 108 will absorb the light and emit the light 144 at other slightly shifted frequencies or wavelengths. The shifted frequencies or wavelengths of the light 144 vary depending upon the vibrational spectrum of the molecule 108 being excited. Different molecules have different vibrational spectra and thus emit Raman scattered light having different shifted frequencies or wavelengths.

The filters in the array 120 are designed and fabricated to have relatively high reflection or transmission characteristics over various wavelength ranges or bands to thereby control the wavelengths of the light 144 that reach the array of photodetectors 110. In this regard, for instance, the filters in the array of filters 120 are designed and fabricated to enable particular wavelengths of light to pass therethrough to thereby enable detection of particular types of molecules.

The substrate 102 is depicted as supporting a plurality of SERS-active nano-particles 104 and may thus comprise any suitable material upon which the SERS-active nano-particles 104 may be supported, such as, silicon, metal, plastic, rubber, etc. The SERS-active nano-particles 104 are intended to one or both of enhance Raman scattering and facilitate analyte adsorption. For instance, the nano-particles 104 may comprise a SERS or Raman-active material such as, but not limited to, gold (Au), silver (Ag), and copper (Cu) having nanoscale surface roughness. Nanoscale surface roughness is generally characterized by nanoscale surface features on the surface of the layer(s) and may be produced spontaneously during deposition of the SERS-active nano-particles 104. By definition herein, a Raman-active material is a material that facilitates Raman scattering and the production or emission of the Raman signal from an analyte adsorbed on or in a surface layer or the material during Raman spectroscopy.

The SERS-active nano-particles 104 may be deposited onto the substrate 102 through, for instance, physical vapor deposition (PVD), chemical vapor deposition (CVD), sputtering, etc., of metallic material, or self-assembly of pre-synthesized nano-particles. In addition, the SERS-active nano-particles 104 may be deposited onto the substrate 102 to form a substantially continuous sheet of material. Moreover, although the substrate 102 has been depicted as having a relatively flat surface, the substrate 102 may be formed with other surfaces, such as, indentations and/or protrusions without departing from a scope of the apparatus 100 disclosed herein.

In some examples, the nano-particles 104 may be annealed or otherwise treated to increase nanoscale surface roughness of the active nano-particles 104 after deposition. Increasing the surface roughness may enhance Raman scattering from an adsorbed analyte, for example. Alternatively, the arrangement of the nano-particles 104 may provide a nanoscale roughness that enhances Raman scattering, for example. The SERS-active nano-particles 104 may be omitted in apparatuses 100 that detect molecules through operations other than SERS.

The array of photodetectors 110 has been depicted as including four photodetectors 112-118 for purposes of illustration. It should, however, be clearly understood that the apparatus 100 may include any number of photodetectors 112-118, including a single photodetector 112, without departing from a scope of the apparatus 100. Generally speaking, each of the photodetectors 112-118 comprises a broadband light detector configured to detect light at multiple wavelengths. In addition, each of the photodetectors 112-118 is in communication with a measuring apparatus 130, which may be configured to process signals communicated by the photodetectors 112-118 to determine, for instance, whether particular wavelengths of light have been detected by the photodetectors 112-118. Thus, for instance, the measuring apparatus 130 may determine and track when light is detected by the photodetectors 112-118. In other examples, the measuring apparatus 130 may determine and track the wavelengths of light detected by the photodetectors 112-118 to determine if the excited molecule 108 matches a predetermined type of molecule.

The array of filters 120 includes a plurality of sub-wavelength grating (“SWG”) filters 122-128. As discussed in greater detail herein below, each of the SWG filters 122-128 comprises one or more patterns to cause light within certain wavelength bands to be transmitted through the SWG filters 122-128 while causing light within other wavelength bands to be reflected or directed in a direction away from a respective photodetector 112-118. For instance, the SWG filters 122-128 may be composed of various sub-patterns of lines having particular periods, thicknesses, and widths that cause certain wavelength bands of light to be reflected from or transmitted through the SWG filters 122-128.

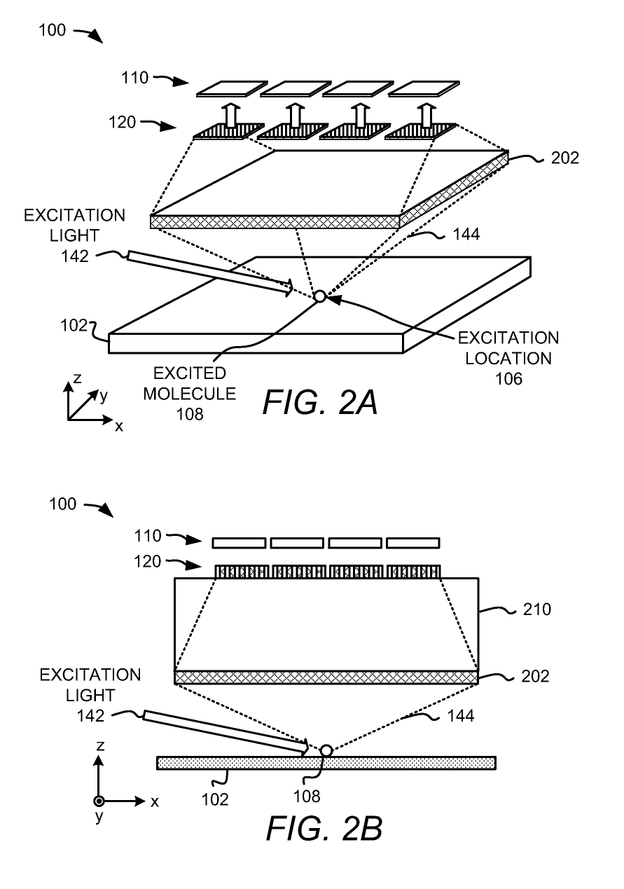

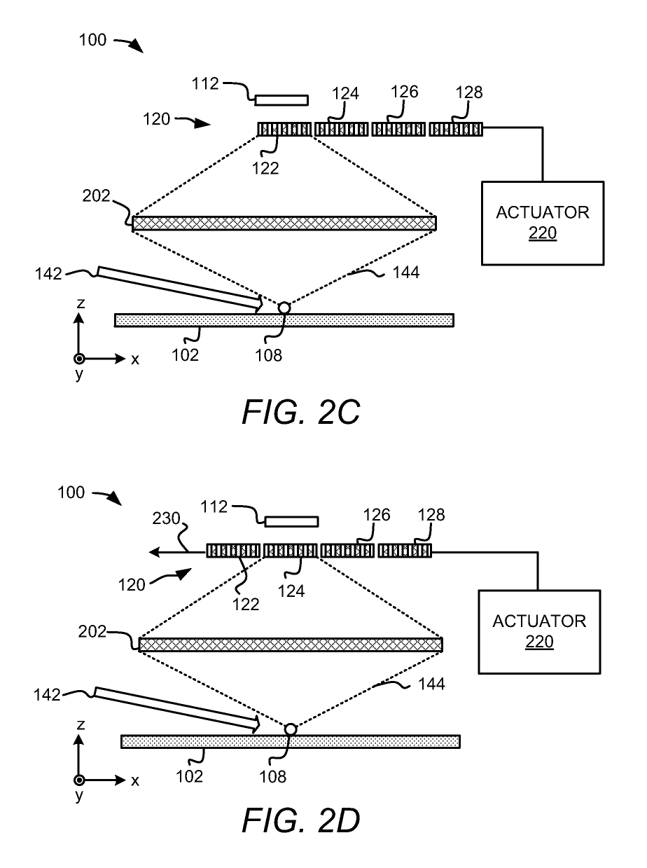

The array of filters 120 has been depicted as including four SWG filters 122-128 for purposes of illustration. It should, however, be clearly understood that the apparatus 100 may include any number of SWG filters 122-128, including a single SWG filter 122, without departing from a scope of the apparatus 100. In addition, although the SWG filters 122-128 have been depicted as being positioned between the photodetectors 112-118 and the substrate 102, in other examples, a larger number of SWG filters 122-128 may be positioned between a lesser number of photodetectors 112-118 and the substrate 102. In these examples, the SWG filters 122-128 may be movable with respect to the photodetector(s) 112-118 to thus enable different wavelengths of light to be filtered out prior to being emitted onto the photodetector(s) 112-118, as discussed in greater detail herein below with respect to FIGS. 2C and 2D.

Generally speaking, the SWG filters 122-128 operate to filter out light having predetermined wavelengths from being emitted onto the photodetectors 112-118. In other words, the SWG filters 122-128 operate to substantially control the wavelengths of light emitted therethrough and onto the photodetectors 112-118. According to an example, each of the SWG filters 122-128 is to filter out light having different ranges of wavelengths with respect to each other. In addition, the filtering characteristics of the SWG filters 122-128 may be selected according to the spectrum of light known to be emitted by a particular type of molecule to be detected by the apparatus 100. By way of example, the Raman signal of a particular type of molecule may be known to include light having four different wavelengths. In this example, each of the four SWG filters 122-128 may be fabricated to filter out light other than one of the three different wavelengths. In addition, a determination that the excited molecule 108 comprises the particular type of molecule may be made if each of the photodetectors 112-118 detects the filtered light. Otherwise, if at least one of the photodetectors fails to detect light, then it may be assumed that the Raman signal emitted from the excited molecule 108 does not include light whose wavelength is within a particular range of wavelengths to be transmitted through at least one of the SWG filters 122-128.

With reference now to FIG. 2A, there is shown a perspective view of the apparatus 100 depicted in FIG. 1, according to another example. The apparatus 100 depicted in FIG. 2A includes all of the same components as those discussed above with respect to FIG. 1A, except that a grating lens 202 is depicted in FIG. 2A as being disposed between the SWG filter array 120 and the substrate 102. In addition, although the substrate 102 has been depicted without the SERS-active nano-particles 104, it should be understood that the substrate 102 may include the SERS-active nano-particles 104 to enable SERS to be performed on an excited molecule 108. Moreover, although not explicitly depicted in FIG. 2A, the photodetectors 112-118 are in communication with the measuring apparatus 130.

The grating lens 202 is generally configured to focus the light 144 emitted from the excited molecule 108 onto the SWG filters 122-128 as indicated by the dotted lines in FIG. 2A. The grating lens 202 generally enables the SWG filters 122-128 and the photodetectors 112-118 to be positioned at a relatively larger distance from the substrate 102 than in FIG. 1. According to an example, similarly to the SWG filters 122-128, the grating lens 202 comprises a sub-wavelength grating (SWG).

Turning now to FIG. 2B, there is shown a cross-sectional side view of the apparatus 100, according to another example. As shown in FIG. 2B, a transparent block 210 is positioned between the grating lens 202 and the SWG filters 122-128 to, for instance, maintain a predetermined distance between the grating lens 202 and the SWG filters 122-128. In one example, the grating lens 202 and the SWG filters 122-128 are attached to the transparent block 210 through use of a suitable attachment mechanism, such as, adhesives, heating, etc. In another example, the grating lens 202 and/or the SWG filters 122-128 are integrally formed into the transparent block 210. In this example, the grating lens 202 and the SWG filters 122-128 may be formed onto opposing sides of the transparent block 210 using any of, for instance, reactive ion etching, focusing beam milling, nanoimprint lithography, etc., to form SWG patterns of the SWG filters 122-128 and the grating lens 202. In this regard, the grating lens 202, the SWG filters 122-128, and the transparent block 210 may be formed as a monolithic block. In addition, the photodetectors 112-118 and the measuring apparatus 130 may also be positioned with respect to the monolithic block, to thereby fabricate the apparatus 100 substantially as a monolithic device.

With reference now to FIGS. 2C and 2D, there are shown cross-sectional side views of the apparatus 100 depicted in FIG. 2A at different times during a spectroscopy operation on an excited molecule 108, according to an example. The apparatus 100 depicted in FIGS. 2C and 2D includes all of the components of the apparatus 100 discussed above with respect to FIG. 1, except that a single photodetector 112 is positioned to detect light being emitted through the SWG filters 122-128. In addition, although the substrate 102 has been depicted without the SERS-active nano-particles 104, it should be understood that the substrate 102 may include the SERS-active nano-particles 104 to enable SERS to be performed on an excited molecule 108. Moreover, although not explicitly depicted in FIG. 2A, the photodetector 112 is in communication with the measuring apparatus 130.

As shown in FIG. 2C, at a first time, a first SWG filter 122 is positioned in front of the photodetector 112. In this regard, the light 144 emitted from the excited molecule 108 is required to be transmitted through the first SWG filter 122 prior to reaching the photodetector 112. More particularly, the grating lens 202 focuses the light 144 emitted from the excited molecule 108 onto a first SWG filter 122. In this regard, the SWG filter 122 may receive a relatively higher intensity light as compared with the examples depicted in FIGS. 2A and 2B. In another regard, the apparatus 100 depicted in FIGS. 2C and 2D may be relatively smaller and less expensive to manufacture as compared with the apparatus 100 depicted in FIGS. 2A and 2B because the apparatus 100 depicted in FIGS. 2C and 2D requires a lesser number of photodetectors.

As shown in FIG. 2D, at a second time, the filter array 120 is moved as indicated by the arrow 230 to position a second SWG filter 124 in front of the photodetector 112. An actuator 220, such as, an encoder, microelectromechanical systems (MEMS), or other actuating device, is depicted as moving the filter array 120. In this regard, the actuator 220 may move the filter array 120 by the length of one of the SWG filters 122 during consecutive time periods to cause the light 144 emitted from the excited molecule 108 to sequentially be filtered by each of the SWG filters 122-128.

Although the actuator 220 has been depicted in FIGS. 2C and 2D as varying the positions of the SWG filter array 120 with respect to the photodetector 112 and the substrate 102, it should be understood that the actuator 220 may instead vary the positions of the photodetector 112 and the substrate 102, and in certain instances, the grating lens 202, with respect to the SWG filter array 120 without departing from a scope of the apparatus 100.

According to another example, the grating lens 202 may be formed on the transparent block 210 as depicted in FIG. 2B. In this example, the SWG filters 124 may be slidably positioned on the transparent block 210 or may be positioned in spaced relation to the transparent block 210.

According to a further example, and with reference back to FIGS. 1, 2A, and 2B, the excitation location 106 may be varied with respect to the substrate 102. In this example, the positions of the SWG filters 122-128 and the photodetectors 112-118 may be varied with respect to the substrate or vice versa. In addition, in the examples depicted in FIGS. 2A and 2B, the position of the grating layer 202 may also be varied along with the positions of the SWG filters 122-128 and the photodetectors 112-118. More particularly, for instance, the excitation light 142 may illuminate a relatively large area of the substrate 102 and the relative positions of the SWG filters 122-128, the grating layer 202, and in certain instances, the grating layer 202, with respect to the substrate 102 may be varied to enable spectroscopy operations to be performed on multiple locations of the substrate 102. In any regard, an actuator, such as the actuator 220 depicted in FIGS. 2C and 2D, may be implemented to vary the relative positions of the SWG filters 122-128, the grating layer 202, and in certain instances, the grating layer 202 with respect to the substrate 102.

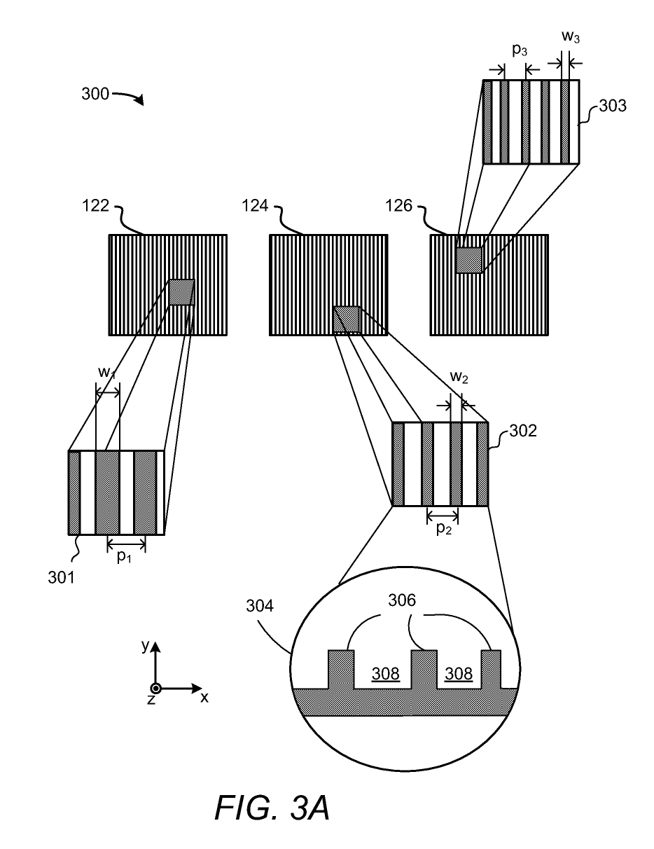

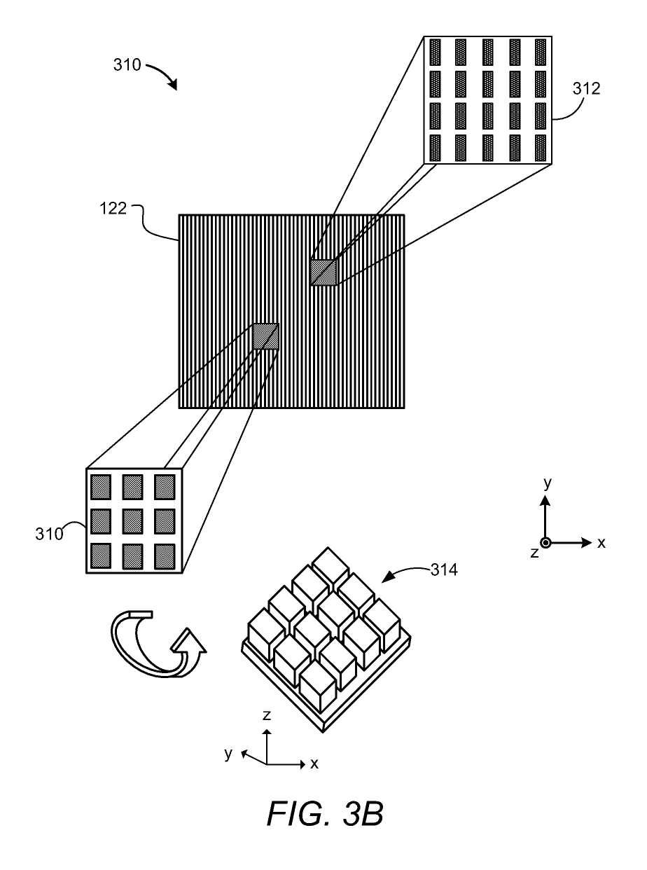

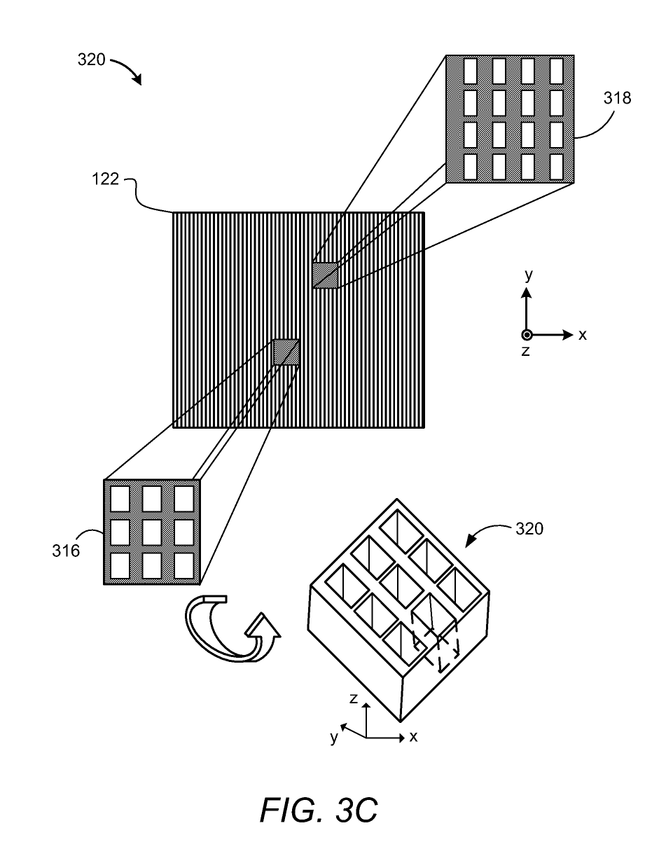

Turning now to FIG. 3A, there is shown a diagram 300 depicting a bottom plan view of three SWG filters 122-126 configured with respective one-dimensional grating patterns, in accordance with an example of the present disclosure. In the diagram 300, the grating sub-patterns 301-303 in the respective SWG filters 122-126 are enlarged. Each of the grating sub-patterns 301-303 is different from each other and are thus arranged to reflect or transmit different wavelength bands of light. In the diagram 300, each grating sub-pattern 301-303 comprises a number of regularly spaced wire-like portions of the SWG filters 122-126 material called “lines” formed in the SWG filters 122-126. The lines extend in the y-direction and are periodically spaced in the x-direction. In other examples, the line spacing may be continuously varying to produce a desired pattern in the beams of light reflected/refracted by the SWG filters 122-126.

The diagram 300 also depicts an enlarged end-on view 304 of the grating sub-pattern 302, which shows that the lines 306 are separated by grooves 308. Each sub-pattern is characterized by a particular periodic spacing of the lines and by the line width in the x-direction. For example, the sub-pattern 301 comprises lines of width w₁ separated by a period p₁, the sub-pattern 302 comprises lines with width w₂ separated by a period p₂, and the sub-pattern 303 comprises lines with width w₃ separated by a period p₃.

The grating sub-patterns 301-303 form sub-wavelength gratings that preferentially reflect or transmit light having predetermined bands of wavelengths. Thus, the first grating sub-pattern 301 may preferentially reflect light in a first wavelength band, the second grating sub-pattern 302 may preferentially reflect light in a second wavelength band, and the third grating sub-pattern 303 may preferentially reflect light in a third wavelength band. For example, the lines widths may range from approximately 10 nm to approximately 300 nm and the periods may range from approximately 20 nm to approximately 1 μm depending on the wavelength of the incident light.

The respective wavelength bands that the SWG filters 122-126 are to reflect out or transmit may be controlled by adjusting the period, line width and line thickness of the lines forming the respective SWG filters 122-126. For example, a particular period, line width and line thickness may be suitable for reflecting or transmitting a certain wavelength band of light, but not for reflecting or transmitting another wavelength band of light; and a different period, line width and line thickness may be suitable for reflecting or transmitting another wavelength band of light. In this regard, particular periods, line widths and line thicknesses may be selected for the SWG filters 122-126 to thereby control the wavelength bands of light that are reflected from or transmitted through the SWG filters 122-126. In addition, the lines forming the SWG filters 122-126 may be arranged in various configurations in each of the SWG filters 122-126, either periodic or non-periodic.

The SWG filters 122-126 are not limited to one-dimensional gratings. Instead, the SWG filters 122-126 may be configured with a two- dimensional, grating pattern. FIGS. 3B-3C show diagrams 310 and 320, which respectively depict bottom plan views of two example planar SWG filters 122-126 with two-dimensional sub-wavelength grating patterns, according to two examples of the present disclosure.

In the diagram 310 of FIG. 3B, the SWG filter 122 is depicted as being composed of posts rather than lines separated by grooves. The duty cycle and period may be varied in the x- and y-directions. Enlargements 310 and 312 show two different post sizes. FIG. 3B includes an isometric view 314 of posts comprising the enlargement 310. The posts are not limited to rectangular shaped posts, in other examples, the posts may be square, circular, elliptical or any other suitable shape. In the diagram 320 of FIG. 3C, the SWG filter 122 is depicted as being composed of holes rather than posts. Enlargements 316 and 318 show two different rectangular-shaped hole sizes. The duty cycle may be varied in the x- and y-directions. FIG. 3C includes an isometric view 320 comprising the enlargement 316. Although the holes shown in FIG. 3C are rectangular shaped, in other examples, the holes may be square, circular, elliptical or any other suitable shape.

According to an example, the grating lens 202 is also formed with SWGs in any of the manners depicted above with respect to FIGS. 3A-3C. However, the SWG pattern(s) for the grating lens 202 may be designed and fabricated with varying sub-patterns throughout the grating lens 202 to cause light to be directed toward an SWG filter 122-128 as shown in FIGS. 2A-2D. In this regard, and in contrast to the SWG filters 122-128, the grating lens 202 is designed and fabricated to transmit all or nearly all of the wavelengths of light contained in the emitted light 144.

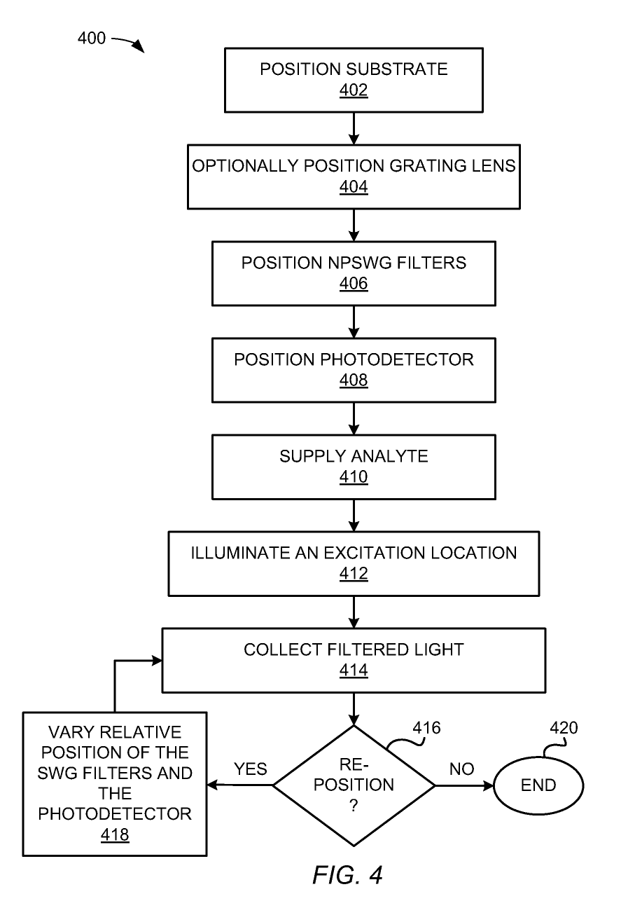

Turning now to FIG. 4, there is shown a flow diagram of a method 400 for performing spectroscopy, such as through surface enhanced Raman spectroscopy (SERS), according to an example. It should be understood that the method 400 is a generalized illustration and that additional steps may be added and/or existing steps may be modified or removed without departing from the scope of the method 400. The method 400 is described with reference to the apparatuses 100 depicted in FIGS. 1-2D. It should, however, be understood that the method 400 may be implemented in a differently configured apparatus without departing from a scope of the method 400.

At block 402, a substrate 102 is positioned to support a molecule 108 to be tested. The substrate 102 may be coated with the SERS-active nano-particles 104 to enhance Raman light emission from the molecule 108 as discussed above with respect to FIG. 1. In addition, the SERS-active nano-particles 104 may be deposited onto the substrate 102 either before or after the substrate 102 is positioned at block 402.

At block 404, a grating lens 202 is optionally positioned in spaced relation to the substrate 102, for instance, as shown in FIGS. 2A-2D. The grating lens 202 is optional as the apparatus 100 may, in various instances, function without the grating lens 202, as shown in FIG. 1. The grating lens 202 may be positioned or formed on a transparent block 210 as shown in and discussed with respect to FIG. 2B. In addition, the grating lens 202/transparent block 210 may be held in place with respect to the substrate through use of any reasonably suitable mechanical structure that does not substantially impede the transmission of light through the grating lens 202/transparent block 210.

At block 406, a plurality of SWG filters 122-128 are positioned in spaced relation to the substrate 102. In the example depicted in FIG. 1, the SWG filters 122-128 are positioned in the path of the light 144 emitted from the excited molecule 108. In the example depicted in FIGS. 2A-2D, the grating lens 202 (and the transparent block 210) are positioned between the SWG filters 122-128 and the substrate 102. The SWG filters 122-128 may also be positioned on or formed in the transparent block 210 as shown in and discussed with respect to FIG. 2B.

According to an example, prior to positioning the SWG filters 122-128, the wavelength bands of light that the SWG filters 122-128 are to filter out are identified. That is, for instance, the wavelength bands of light that the SWG filters 122-128 are to filter out are identified based upon the light emitting characteristics of a molecule 108 to be tested. Thus, by way of example in which a particular molecule is known to emit light having a particular spectrum, the SWG filters 122-128 may be designed and fabricated to filter out light having wavelengths that are outside of the particular spectrum. In this regard, each of the SWG filters 122-128 may be designed and fabricated to filter out different wavelength bands of light with respect to each other. Alternatively, SWG filters to filter out different wavelength bands of light may previously have been fabricated and block 406 may include selection of the appropriate SWG filters.

At block 408, a photodetector 112 is positioned behind one of the SWG filters 122-128. In the example depicted in FIG. 1, a plurality of photodetectors 112-118 are positioned behind the SWG filters 122-128, such that, a particular SWG filter 122-128 filters light to be collected by a respective one of the photodetectors 112-118. In the example depicted in FIGS. 2C and 2D, a single photodetector 112 is positioned a particular one of the SWG filters 122-128 at a given time.

At block 410, analyte 152 that may contain a particular type of molecule to be tested is supplied onto the substrate 102, for instance, from the analyte source 150. At block 412, an excitation location 106 on the substrate 102 is illuminated, for instance, by the illumination source 140. As discussed above, the molecule 108 may absorb the excitation light 142 and may emit light 144 at slightly shifted frequencies or wavelengths as compared with the frequency of the excitation light 142. In addition, the light 144 travels through a SWG filter 122 prior to reaching a photodetector 112. In the examples of FIGS. 2A-2D, the light 144 also travels through the grating lens 202 prior to reaching the SWG filters 122-128.

At block 414, the light filtered by the SWG filter 122 may be collected by the photodetector 112. The photodetector 112 may collect the light if at least some of the wavelengths of light have not been filtered out by the SWG filter 122. More particularly, if the light 144 contains only wavelengths that the SWG filter 122 is to filter out, then no light is emitted onto the photodetector 112. In this regard, a determination as to whether the 144 contains a spectrum of wavelengths associated with a particular type of molecule may be made based upon which of the wavelengths of light are collected by the photodetectors 112-114.

At block 416, a determination as to whether a relative position of the SWG filter 122 and the photodetector 112 is to be varied is made. In response to a determination that the relative position of the SWG filter 122 and the photodetector 112 is to be varied, the relative position of the SWG filter 122 and the photodetector 112 is varied at block 418. Blocks 416 and 418 thus pertain to the features depicted in FIGS. 2C and 2D. Following movement of one of the SWG filter 122 and the photodetector 112 to position a different SWG filter 124 in front of the photodetector 112, the photodetector 112 may attempt to collect the light 144 filtered by the second SWG filter 124. In addition, blocks 414-418 may be repeated until each of the SWG filters 122-128 has been positioned in front of photodetector 112, at which time the method 400 may end, as indicated at block 420.

Following termination of the method 400, the data pertaining to which wavelength bands of light were not filtered out and thus were collected by the photodetector 112 may be analyzed to determine, for instance, whether the molecule is or is likely a particular type of molecule. More particularly, for instance, if the data indicates that the wavelength bands of light that were collected meet a particular spectrum, then a determination that the particular type of molecule is present. Otherwise, a determination that the particular type of molecule is not present may be made.

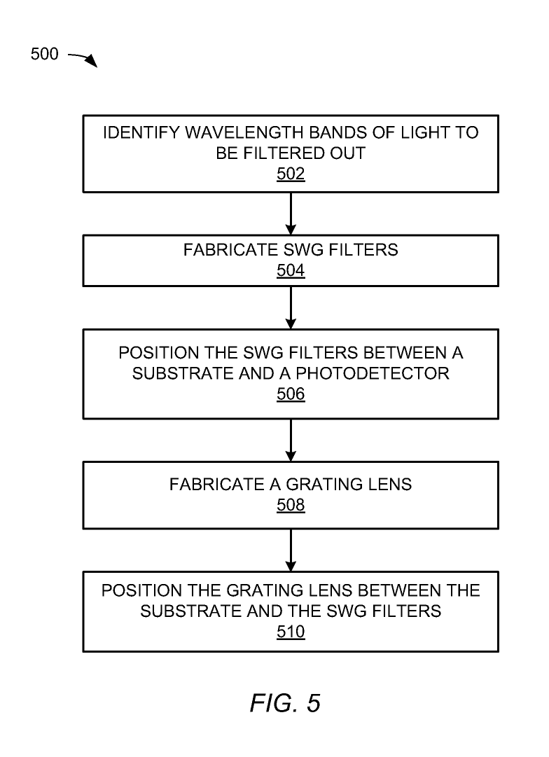

Turning now to FIG. 5, there is shown a flow diagram of a method 500 for fabricating a spectroscopy apparatus, according to an example. It should be understood that the method 500 is a generalized illustration and that additional steps may be added and/or existing steps may be modified or removed without departing from the scope of the method 500.

At block 502, wavelength bands of light to be filtered out by a plurality of SWG filters 122-128 are identified. As discussed above, the wavelength bands of light to be filtered out may comprise those wavelength bands of light that are outside of a spectrum of wavelengths known to be emitted by a particular molecule. As such, the wavelength bands to be filtered out generally differ for different types of molecules. In one regard, therefore, the apparatus 100 fabricated through the method 500 may be functionalized to detect a particular type of molecule as opposed to attempting to determine the entire spectrum of light emitted by the molecule being tested.

At block 504, the SWG filters 122-128 are fabricated. Block 504 may include a process of determining the sub-patterns to be applied onto each of the SWG filters 122-128 to achieve the desired filtering characteristics. More particularly, for instance, the line widths, line period spacings, and line thicknesses for the sub-patterns of each of the SWG filters 122-128 that result in the desired reflection and transmission characteristics may be determined at block 504. This determination may be automated, for instance, through computer simulation, or may be made based upon testing of various sub-patterns. In any event, the SWG filters 122-128 may be fabricated to include the determined patterns at block 504. By way of example, the SWG filters 122-128 may be fabricated through reactive ion etching, focusing beam milling, nanoimprint lithography, etc. In addition, each of the SWG filters 122-128 may be fabricated on a common block of material in one patterning step.

The fabrication of the SWG filters 122-128 may be performed by a computing device. For instance, the computing device may calculate the line widths, line period spacings, and line thicknesses for the grating layer corresponding to the desired pattern across the grating layer and may also control a micro-chip design tool (not shown) configured fabricate the SWG filters 122-128. According to an example, the micro-chip design tool is to pattern the lines of the SWG filters 122-128 directly on a first layer of material. According to another example, the micro-chip design tool is to define a grating pattern of the lines in an imprint mold, which may be used to imprint the lines into a first layer positioned on the surface of a material from which the SWG filters 122-128 are fabricated. In this example, the imprint mold may be implemented to stamp the pattern of the lines into the first layer. In either example, the SWG filters 122-128 may be fabricated adjacent to each other on the same block of material.

At block 506, the SWG filters 122-128 are positioned between the substrate 102 and the photodetector 112, as depicted in FIGS. 1-2D. In one example, the apparatus 100 may be completed following block 506. In another example, however, at block 508, a grating lens 202 is fabricated and at block 510, the grating lens 202 is positioned between the substrate 102 and the SWG filters 122-128.

As discussed above, the grating lens 202 is generally designed to focus the light 144 emitted from the excited molecule 108 onto an SWG 112. In this regard, and according to an example, the grating lens 202 may be formed as a concave and/or a convex lens. According to another example, the grating lens 202 also comprises a SWG lens comprising various sub-patterns of lines. In this example, a process of determining the sub-patterns to be applied on the grating lens 202 to achieve desired optical characteristics may be performed. More particularly, for instance, the line widths, line period spacings, and line thicknesses for the sub-patterns for the grating lens 202 that result in the desired focusing of light may be determined at block 508. This determination may be automated, for instance, through computer simulation, or may be made based upon testing of various sub-patterns. In any event, the grating lens 202 may be fabricated to include the determined patterns. By way of example, the grating lens 202 may be fabricated through reactive ion etching, focusing beam milling, nanoimprint lithography, etc.

The fabrication of the grating lens 202 may be performed by a computing device. For instance, the computing device may calculate the line widths, line period spacings, and line thicknesses for the grating layer corresponding to the desired pattern across the grating layer and may also control a micro-chip design tool (not shown) configured fabricate the grating lens 202.

According to an example, the grating lens 202 may be fabricated on one side of a transparent block 210 as depicted in FIG. 2B. In addition, both the grating lens 202 and the SWG filters 122-128 may be fabricated, for instance, through reactive ion etching, focusing beam milling, nanoimprint lithography, etc., on opposite sides of a transparent block 210. In this regard, therefore, some of the optical elements implemented in the SERS apparatus 100 may be fabricated in a relatively simple and efficient manner.

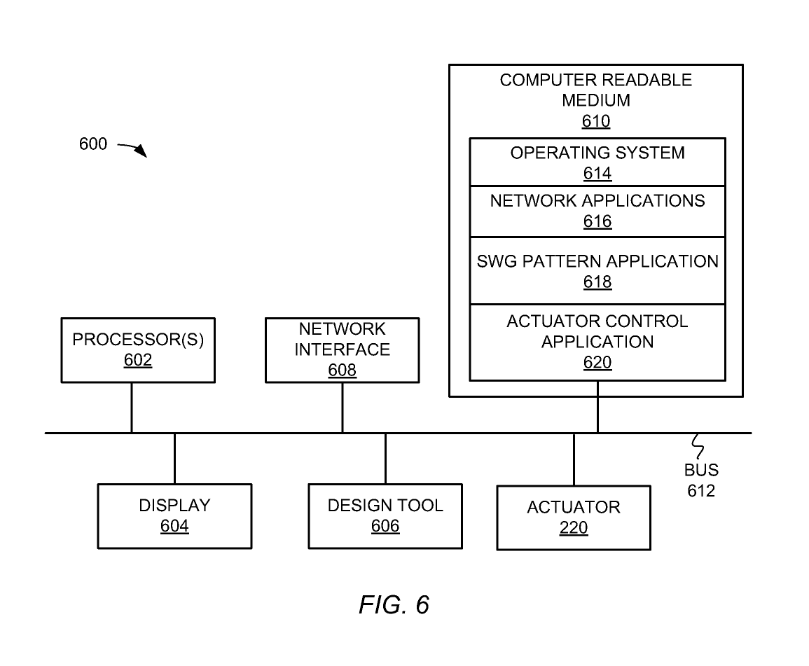

The methods employed to fabricate the SWG filters 122-128 and the grating lens 202 with reference to FIG. 5 may be implemented by a computing device, which may be a desktop computer, laptop, server, etc. Turning now to FIG. 6, there is shown a schematic representation of a computing device 600 that may be implemented to perform various functions with respect to the apparatus 100, according to an example. The computing device 600 includes one or more processors 602, such as a central processing unit; one or more display devices 604, such as a monitor; a design tool interface 606; one or more network interfaces 608, such as a Local Area Network LAN, a wireless 802.11x LAN, a 3G mobile WAN or a WiMax WAN; and one or more computer-readable mediums 610. Each of these components is operatively coupled to one or more buses 612. For example, the bus 612 may be an EISA, a PCI, a USB, a FireWire, a NuBus, or a PDS.

The computer readable medium 610 may be any suitable non-transitory medium that participates in providing machine readable instructions to the processor 602 for execution. For example, the computer readable medium 610 may be non-volatile media, such as an optical or a magnetic disk; volatile media, such as memory; and transmission media, such as coaxial cables, copper wire, and fiber optics. The computer readable medium 610 may also store other software applications, including word processors, browsers, email, Instant Messaging, media players, and telephony software.

The computer-readable medium 610 may also store an operating system 614, such as Mac OS, MS Windows, Unix, or Linux; network applications 616; and a SWG pattern application 618. The operating system 614 may be multi-user, multiprocessing, multitasking, multithreading, real-time and the like. The operating system 614 may also perform basic tasks such as recognizing input from input devices, such as a keyboard or a keypad; sending output to the display 604 and the design tool 606; keeping track of files and directories on medium 610; controlling peripheral devices, such as disk drives, printers, image capture device; and managing traffic on the one or more buses 612. The network applications 616 include various components for establishing and maintaining network connections, such as software for implementing communication protocols including TCP/IP, HTTP, Ethernet, USB, and FireWire.

The SWG pattern application 618 provides various software components for generating grating pattern data for the SWG filters 122-128 and the grating lens 202, as described above. In certain examples, some or all of the processes performed by the application 618 may be integrated into the operating system 614. In certain examples, the processes may be at least partially implemented in digital electronic circuitry, or in computer hardware, firmware, machine readable instructions, or in any combination thereof.

According to an example, the computing device 600 may control the actuator 220 to vary the relative position of the SWG filters 122-128 and the photodetector 112, as discussed above with respect to FIGS. 2C and 2D. In this regard, the computer-readable medium 610 may also have stored thereon an actuator control application 620, which provides various software components for controlling the actuator 220 in varying the position of one or both of the SWG filters 122-128 and the photodetector 112 as discussed above.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. An apparatus for performing spectroscopy, said apparatus comprising:
a substrate;
a photodetector positioned at a distance with respect to the substrate; and
a plurality of sub-wavelength grating (SWG) filters positioned between the substrate and the photodetector, wherein the SWG filters are to filter different ranges of predetermined wavelengths of light emitted from a molecule at an excitation location prior to being emitted onto the photodetector.

2. The apparatus according to claim 1, wherein the predetermined wavelengths of light to be filtered by each of the plurality of SWG filters are selected to determine the presence of a molecule known to emit Raman scattered light having wavelengths outside of the filtered predetermined wavelengths.

3. The apparatus according to claim 1, further comprising:
a grating lens positioned between the SWG filters and the substrate, wherein the grating lens is to focus light emitted from an excitation location on the substrate onto an SWG filter of the plurality of SWG filters.

4. The apparatus according to claim 3, wherein the grating lens and the SWG filters are formed in a common monolithic block.

5. The apparatus according to claim 1, further comprising:
an illumination source to emit light onto the excitation location.

6. The apparatus according to claim 5, wherein the substrate the photodetector, the SWG filters, and the illumination source are fabricated as a monolithic device.

7. The apparatus according to claim 1, wherein relative positions of the SWG filters and the photodetector are variable to enable a different SWG filter to filter light emitted onto the photodetector at a given time.

8. A method of implementing the apparatus of claim 1 to perform spectroscopy, said method comprising:
positioning the substrate to support the molecule to be tested;
positioning the plurality of sub-wavelength grating (SWG) filters in spaced relation to the substrate; and
positioning the photodetector at a location with respect to the plurality of SWG filters to detect light emitted from the molecule to be tested through the plurality of SWG filters.

9. The method according to claim 8, further comprising:
supplying an analyte onto the substrate;
illuminating an excitation location on the substrate to cause light to be emitted by a molecule of the analyte and collecting the emitted light in the photodetector, wherein the plurality of SWG filters are to filter the emitted light prior to the light being emitted onto the photodetector.

10. The method according to claim 8, further comprising:
varying a relative position of the plurality of SWG filters and the photodetector to cause the light emitted from the molecule to be tested to be emitted through different ones of the plurality of SWG filters over periods of time.

11. The method according to claim 8, further comprising:
positioning a grating lens between the substrate and the plurality of SWG filters, wherein the grating lens is to focus light emitted from an excitation location on the substrate onto an SWG filter of the plurality of SWG filters.

12. The method according to claim 11, wherein the grating lens is integrated into a transparent block and wherein positioning the grating lens further comprises positioning the transparent block between the substrate and the plurality of SWG filters.

13. The method according to claim 11, wherein the grating lens and the plurality of SWG filters are integrated into a transparent block, and wherein positioning the plurality of SWG filters further comprises positioning the transparent block between the substrate and the photodetector.

14. A method of fabricating the apparatus of claim 1, said method comprising:
fabricating the plurality of sub-wavelength grating (SWG) filters to filter out different wavelengths of light with respect to each other; and
positioning the plurality of SWG filters in spaced relation between the substrate and the photodetector.

15. The method according to claim 14, further comprising:
fabricating a grating lens and positioning the grating lens between the substrate and the plurality of SWG filters, wherein the grating lens is to focus light emitted from the molecule in the excitation location onto an SWG filter of the plurality of SWG filters.
